(19) United States
(12) Patent Application Publication
(10) Pub. No.: US 2013/0073327 A1
(43) Pub. Date: Mar. 21, 2013

(54) URBAN TRANSPORTATION SYSTEM AND METHOD

(71) Applicant: Benjamin J. Edelberg, Woodland Hills, CA (US)

(72) Inventor: Benjamin J. Edelberg, Woodland Hills, CA (US)

(21) Appl. No.: 13/563,618

(22) Filed: Jul. 31, 2012

Related U.S. Application Data
(60) Provisional application No. 61/626,123, filed on Sep. 20, 2011.

(51) Int. Cl. G06Q 10/06; G06Q 40/00

(52) U.S. Cl. 705/7.13

(57) ABSTRACT

A transportation system and a method for operating the transportation system are provided. The transportation system provides a flexible, on-demand, and door-to-door transportation service to improve the accessibility of an existing public transit system. The transportation system may be operated by or in conjunction with the transit system and is uniquely different from either taxi, shuttle, or bus service. A vehicle of the transportation system transports a passenger between a pickup location and a predetermined node in response to a service request initiated by the passenger according to instructions that are dynamically determined in real time in consideration of the pickup location, a current location of the vehicle, and a predetermined travel time between the pickup location and the node.

### CROSS-REFERENCE TO RELATED APPLICATION(S)

This application claims priority to and the benefit of Provisional Application No. 61/626,123, filed on Sep. 20, 2011, the disclosure of which is incorporated herein in its entirety by reference.

### BACKGROUND

1. Field

Aspects of the present invention relate to an urban transportation system and methods for operating the same, and more particularly, an urban transportation system having multiple fleets respectively assigned to partially overlapping service areas.

2. Description of Related Art

Personal automobiles are generally considered the most flexible form of daily transportation for commuters and passengers within urban environments. In response, extensive infrastructure has been built in many cities to accommodate personal automobiles as the de-facto method of transport and mobility. As the populations of the cities increase, and the corresponding number of automobiles on highways and streets increases, congestion and pollution have also increased. It is generally considered to be more environmental friendly to increase the usage of shared transportation such as mass transit or group transportation options for commuting and performing routine chores within the city rather than using individual automobiles. While many cities have built and/or improved their public transports or transit systems (e.g., commuter trains, metro trains, subways, buses, etc.), these cities often face difficulties in increasing the utilization of their public transit systems due to the low density urban sprawl developed in response to individual automobile usage which characterizes the urban planning of most modern cities. These public transit systems are often inaccessible and inconvenient to a significant number of city dwellers due to significant distances that exist between the transit nodes (stations, hubs, or depots) and the passengers' origins and/or destinations.

Among the commonly used public transit systems, public buses are generally more flexible than rail transits and can be more accessible to the passengers at their respective origins and/or destinations. However, public buses still provide only a partial solution to the inaccessibility problems because typical bus-scheduling yields commutes that are often undesirably longer than one would expect from using a personal automobile. Furthermore, it is generally considered undesirable to use the buses for commuting because a typical trip often involves multiple transfers and wait times between individual bus routes, and may even include additional train rides and inevitable walks between a transit node (e.g., station) and a passenger's origin/destination. As described above, the typical geographic nature of low-density urban growth and the planning of suburbs make commuting using public transports very inconvenient. Therefore, it is difficult for transit organizations to encourage significant numbers of passengers to switch from using their personal automobiles to public transports.

Other significant drawbacks to public transports in comparison to personal automobiles include less privacy and flexibility. The personal automobile provides a high degree of freedom to the passenger or driver who is accustomed to a personal lifestyle that has been developed around its use. The personal automobile affords the passenger with a mobility option that is flexible and on-demand, and provides a door-to-door service that cannot currently be accommodated by the public transports.

Therefore, it is desirable to provide an urban transportation system that is convenient, flexible, and easily accessible by the passengers. It is also desirable to increase accessibility of the stations or hubs of the urban transportation system such that the stations can provide service to a larger number of passengers.

### SUMMARY

Embodiments of the present invention provide a transportation system that is flexible, convenient, and easily accessible in low population density areas. Embodiments of the present invention also provide a method for operating the above transportation system.

In a first embodiment, a transportation system includes a first fleet configured to operate in a first service zone having a first node to transport passengers exclusively in the first service zone according to instructions dynamically determined in real time; a second fleet configured to operate in a second service zone having a second node, excluding the first node, to transport passengers exclusively in the second service zone according to instructions dynamically determined in real time; and a control center in data communication with the first fleet and the second fleet for providing the instructions to the first fleet and the second fleet. According to the present embodiment, the control center is configured to direct a first vehicle from the first fleet to transport a first passenger between a first location and the first node in response to a service request initiated by the first passenger according to the instructions that are dynamically determined in real time in consideration of the first location, a current location of the first vehicle, and a first predetermined travel time between the first location and the first node.

The first service zone and the second service zone may be partially overlapping each other.

In a second embodiment, a method of operating a transportation service is provided. The method includes operating a first fleet in a first service zone having a first node to transport passengers exclusively in the first service zone according to instructions dynamically determined in real time; operating a second fleet in a second service zone having a second node, excluding the first node, to transport passengers exclusively in the second service zone according to instructions dynamically determined in real time. According to the present embodiment, a first vehicle from the first fleet is directed to transport a first passenger between a first location and the first node in response to a service request initiated by the first passenger according to the instructions that are dynamically determined in real time in consideration of the first location, a current location of the first vehicle, and a first predetermined travel time between the first location and the first node.

In several embodiments, the first service zone and the second service zone are partially overlapped such that the first vehicle may not transport the first passenger from the first location to a destination further than that to the second node of the second service zone. However, in various embodiments, the first vehicle may be permitted to transport the first passenger beyond the first service zone in exceptional cases such as an emergency or severe traffic congestion.

In another embodiment, a transportation system includes a fleet configured to operate in a service zone to transport passengers of a node exclusively in the service zone according to instructions dynamically determined in real time, and a control center in data communication with the fleet for providing the instructions to the fleet. According to the present embodiment, the control center is configured to direct a vehicle from the fleet to transport a first passenger between a first location and the node in response to a service request initiated by the first passenger according to the instructions that are dynamically determined in real time in consideration of the first location, a current location of the vehicle, and a predetermined travel time between the first location and the first node.

The first vehicle may be directed to pickup a second passenger from a second location in the same service zone in response to a service request initiated by the second passenger while transporting the first passenger. The control center may modify the instructions in real time in consideration of the second location of the second passenger such that the first passenger is transported to the first node or the first location within the predetermined travel time.

In several embodiments, the service zone may have an adjustable size that can be dynamically adjusted based on a desired travel time or distance of a vehicle of the fleet. The predetermined travel time between the first location and the first node may be determined based on a travel time limit, a travel distance limit, or a combination thereof. In one embodiment, the first passenger is transported between the first location and the node in fifteen minutes or less. In one embodiment, a distance between the first location and the node is 4 miles or less. In one embodiment, the node may be a mass transit hub or station.

### BRIEF DESCRIPTION OF THE DRAWINGS

The above and other features and aspects of the present invention will become more apparent by describing in several detail embodiments thereof with reference to the attached drawings in which:

FIG. 1 is a conceptual diagram illustrating a transportation system providing a flexible door-to-door transportation service to a service zone around a single transit node according to an embodiment of the present invention;

FIG. 2 is a diagram illustrating a service area having an energy distribution source according to an embodiment of the present invention;

FIG. 3 is a diagram illustrating the flow of commuters between two transit nodes that are connected by a transit train according to an embodiment of the present invention;

FIG. 4 is a diagram conceptually illustrating an access model of a number of subdivided zones across a hypothetical transit network according to an embodiment of the present invention;

FIGS. 5a through 5c are diagrams conceptually illustrating a strategic distribution of a fleet of vehicles in a service zone according to an embodiment of the present invention;

FIGS. 6a and 6b are diagrams illustrating a hypothetical demand structure exhibited by five distinct commuters as they enter an on-demand transportation network according to an embodiment of the present invention; and

FIG. 7 is a block diagram illustrating a computer system for handling the various functions of a door-to-door on-demand transportation system as illustrated in reference to FIGS. 1 through 6.

FIG. 8 is a flowchart illustrating processes performed by the computer system of FIG. 7 to determine an itinerary for a passenger according to an embodiment of the present invention.

### DETAILED DESCRIPTION OF THE EMBODIMENTS

While the present invention has been particularly shown and described with reference to a number of embodiments thereof, it will be understood by those of ordinary skill in the art that various changes in form and details may be made therein without departing from the spirit and scope of the present invention as defined by the following claims, and their equivalents.

Mass transit (e.g., a rail transit or subway) is well suited to a densely populated area because each station can provide service to a large number of passengers who are within walking proximity of the station. The walking proximity is generally determined by an accessibility radius (e.g., 0.5 miles or fifteen minutes walking distance) with the station of the transit system at the center. However, in a low-density environment such as the suburb that has predominantly single family homes, each station of the same mass transit will provide service to a much smaller number of passengers within the same accessibility radius. In other words, the stations of the same mass transit are considered to be inaccessible to a significant number of passengers who are located outside of the accessibility radius.

One solution is to build more stations with shorter distance in between. However, if more stations were built to accommodate the low-density areas in order to provide the same level of pedestrian access as in the densely populated areas, the sheer number of stations required and their relatively minute usage would be unaffordable for the transit system to be built, staffed, and maintained. In low-density areas, it is simply not economical to build enough transit stations relative to population density to provide sufficient passengers with convenient access while maintaining cost efficiency.

Unlike mass transit, personal automobiles offer a mobility option that is flexible and on-demand, and provide a door-to-door service that cannot currently be accommodated by mass transit. However, the use of personal automobiles also brings along undesirable traffic congestion, air pollution, and potentially higher costs.

A traditional taxi service can offer an alternative to the personal automobiles in low-density urban environments. However, even the taxi system is not well suited to the distances involved and the relative number of vehicles necessary to cover a vast low density area such as the suburbs to provide an affordable door-to-door on-demand transportation service. For the taxi service providers, it is simply not economical to provide enough vehicles or taxicabs to saturate the low-density urban environment in a fashion to provide services comparable to those available in higher density cities or downtown regions. In addition, for the taxi service consumers, it is also uneconomical to consider replacing ones private cars with taxi service due to the extensive distances involved.

Besides being uneconomical to provide transportation services in low-density areas using a large number of underutilized taxicabs, increased pollution will result from operating a large number of these fossil fuel burning vehicles. Although the pollution problem can be reduced by using all-electric or plug-in hybrid vehicles, these vehicles are still relatively cumbersome and expensive for widespread consumer use. Some of the drawbacks of all-electric vehicles include long charging time, limited range per charge, limited access to charging stations, etc. Therefore, it is still not practical to use electric taxicabs to replace the conventional fossil fuel burning taxicabs currently in service due to the above drawbacks.

Embodiments of the present invention are directed to an urban transportation system and methods for operating the system such that the stations of an existing mass transit system can be accessible to an increased number of passengers. Embodiments of the present invention provide a solution to the “last-mile” problem in which a subsidiary network of vehicles connects commuters to transit system nodes in about the same time frame (e.g., 15 minutes) as one would expect of a short commute walking distance to a similar node within a higher-density urban area. According to several embodiments of the present invention, a mass transit node presently serving commuters within a desirably short walking distance (e.g., 15 minutes walk or 0.5 miles) can now serve commuters within a significantly expanded distance (e.g., 15 minute drive or 4 mile radius).

Embodiments of the present application are also directed to a transportation system, methods, devices, and a computer system for providing a flexible, on-demand, and door-to-door transportation service. The transportation system as a direct extension of an existing mass transit system, may be operated by or in conjunction with the transit system and is uniquely different from either taxi, shuttle, or bus service. According to the embodiments, multiple commuters or passengers paying separate fares can theoretically share the same vehicle to and from a transit node (or station) as effectively and efficiently as possible. The transportation system is unique in that there are time and/or distance limits, e.g., via a predetermined service radius, as to where a passenger can be transported by the vehicle. In several embodiments, the transportation system is a regionally organized system that is operated as an extension to the transit system. According to several embodiments, the transportation system is operated as a subsidiary system to a metro system, not as an independent form of transportation. This transportation system is designed to get people to and from the metro system within the regions of influence of the metro stations.

The transportation system of the present invention can be described via an analogy to the natural system that links colonies of bees to individual hives. Bees surround the hive collecting pollen that by their numbers efficiently affects a broader service area. This system has three distinct parts: hives, individual bees, and swarms. Multiple bees individually contributing to a swarm together serve to broaden and expand the effective gathering radius of the hive. (e.g., by collecting pollen from many flowers within a given area).

The nodes or stations of a mass transit can be analogized to the “hives.” Besides being access points to the transit network, these “hives” (e.g., nodes) can also be the potential center of activities for the community. A colony of “bees” (e.g., a fleet of passenger vehicles) are specifically assigned to service each “hive” expanding the accessibility of it. Each fleet of the passenger vehicles (“bees”) are specifically assigned to retrieve and deliver passengers within a radial zone generally centered on each unique transit node (“hive”). Each passenger vehicle is organized and routed to transport one or more passengers in a prescribed or promised (or predetermined) delivery time according to instructions that can be dynamically updated. The number of passengers concurrently carried by each vehicle varies and depends on a number of factors such as the location and time of the request, potential additional pickups and/or drop-offs, and the prescribed delivery promise (e.g., 15 minutes or less travel time). In the above-described analogy, the “swarm” includes multiple “bees” surrounding the “hive.”

The transportation system of the present invention has two enabling features: a computer system specially configured to manage the dynamic real-time scheduling and routing of the passenger vehicles, and the strategic dynamic distribution and redistribution of the passenger vehicles within the service area in response to changing transportation demands of the passengers.

The computer system (e.g., a computer or a group of computers) manages the passenger vehicles (“bees”) by dynamically scheduling and directing the routes and schedules of the passenger vehicles to pickup and drop off passengers or commuters at the transit nodes (“hives”). In several embodiments, the individual vehicles are scheduled and directed according to shortest distance algorithms. When a vehicle is en route transporting a passenger to a destination within a set or predetermined time window, real-time and dynamic updates of the progress of the vehicle are available to the computer system so that it can be determined whether additional passenger(s) can be accommodated by the vehicle while still delivering the predetermined service time window promise. In several embodiments, a user or a passenger may interact with the transportation system via a personal digital assistant (PDA), a mobile device (e.g., a smartphone or a mobile phone), a landline telephone, or a networked computer, with a suitable interface in communication (e.g., data communication or voice communication) with the system to perform functions related to, for example, requesting services, scheduling routes, controlling and changing the overall routes of the vehicles, or billing of the system. However, the present invention is not limited to the above-described devices and functions.

During operation, standby passenger vehicles (i.e., vehicles not transporting any passengers) of the transportation system are strategically distributed in the service area such that the standby passenger vehicles roaming in the service area generally centered around a mass transit node (“hive”) can be scheduled and routed to pick up a passenger as quickly as possible. Accordingly, the vehicles (“bees”) swarm around the service area to provide the timeliest service, once a commuter has requested service.

The transportation system described above can be operated as an integral part of a mass transit system either working in conjunction with, subsidized by, or directly operated by the operator of the transit system. The embodiments of the present invention offer a new paradigm of shared public transportation with the comfort and ease of a taxi service, and fares for using the transportation service may be based upon a token or credit system providing a single ride fare scenario (e.g., a single use bus or train ticket).

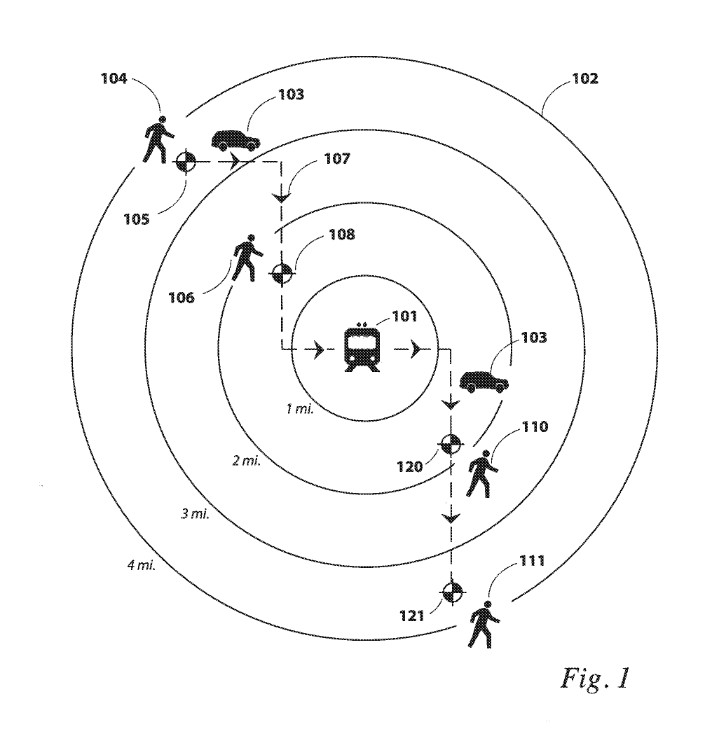

FIG. 1 is a conceptual diagram illustrating a transportation system providing a flexible door-to-door transportation service to a service zone 102 around a single transit node 101 according to an embodiment of the present invention. Referring to FIG. 1, the transit node 101 (e.g., a metro station or hub) is surrounded by the service zone 102 that defines a service area in which the transportation system can deliver a passenger to a destination within a promised time (t) limit. A number of passenger vehicles 103 are assigned to exclusively transport passengers within this pre-defined service zone 102 to/from the transit node 101. In the present disclosure, a vehicle “exclusively” transports passengers within a service zone, and the vehicle does not travel beyond the service zone under normal operations, except in certain exceptional situations such as medical emergency, severe traffic congestion, or other urgent conditions.

Still referring to FIG. 1, a passenger 104 sends or initiates a service request for transportation service to the system via any one of a number of methods to be described below. The system responds by dispatching one of the vehicles 103 to pickup the passenger 104 at a pickup point 105 and transports the passenger 104 to the transit node 101. Here, the system may provide the instructions to the vehicles 103 by any suitable data communication methods that are commonly known in the art such as a mobile communication network, a cellular communication network, etc. Each of the system and the vehicles 103 has suitable data communication equipments such as wireless transmitter and receiver for data communication. The instructions may include a route that reaches the pickup point 105 and the transit node 101, and the route is changeable by the system in real time based on a number of factors to be described in more detail below.

While the vehicle 103 is en route transporting the passenger 104 to the transit node 101, the transportation system may receive a service request from another passenger 106 such that the schedule and/or route of the vehicle 103 may be dynamically updated in real time to pickup the passenger 106 if the following condition is met. The schedule and/or route of the vehicle 103 may be updated to additionally transport the passenger 106 in addition to the passenger 104 if the passenger 104 can still be delivered to the destination without exceeding the service time promise (or limit) to the passenger 104. If the system determines that it is feasible to additionally pickup the passenger 106, the route 107 of the vehicle 103 is dynamically altered in real time to pickup the passenger 106 at a pickup point 108. That is, the vehicle 103 transports both passengers 104 and 106 during at least a portion of the promised service time limit.

However, the transportation system of the present invention is not limited to any specific number of passengers per vehicle, which can carry different numbers of passengers in different embodiments. The transportation system of the present invention is based upon a predetermined service time promise (or limit) which when systematically modeled will determine the suitable size and capacity of the vehicle 103 needed to satisfy the requirements of the system in the service zone 102. Upon arrival at the transit node 101, the passengers 104/106 are dropped off so that they can continue their respective journeys, for example, by riding the trains leaving the transit node 101 or walk to their respective destinations. At this time, the same vehicle 103 that has just delivered the passengers 104/106 can pickup one or more pre-scheduled passengers (e.g., passengers 110/111) at the transit node 101 and deliver them to their drop-off points (e.g., 120/121), respectively. Each of the passengers (e.g., 104/106/110/111) is charged a fare corresponding to their respective usage of the vehicle 103. In several embodiments, the system automatically debits an account of the passenger an amount equal to a fare similar to a token or credit based fee.

Recent urban-planning trend often favors developing urban conveniences and amenities around transit nodes that may develop into popular urban destinations. In one embodiment of the present invention, the transportation system can provide a direct, one-way transportation service to and from these popular urban hubs. In one embodiment, the system ceases to be a subsidiary to a transit node as a part of a larger transit system, but becomes a separate transportation system for providing a one-stop direct transit network based upon popular urban destinations of the communities.

Furthermore, in another embodiment, if a passenger wishes to travel between two points within the same zone (e.g., passengers 104 and 110 are the same passenger), the system can accommodate this travel request by either routing the passenger through the transit node 101, or if dynamically determined to fit within the system's time promise, this passenger can be directly transported from the pick-up point 105 to the drop-off point 120 within the same vehicle.

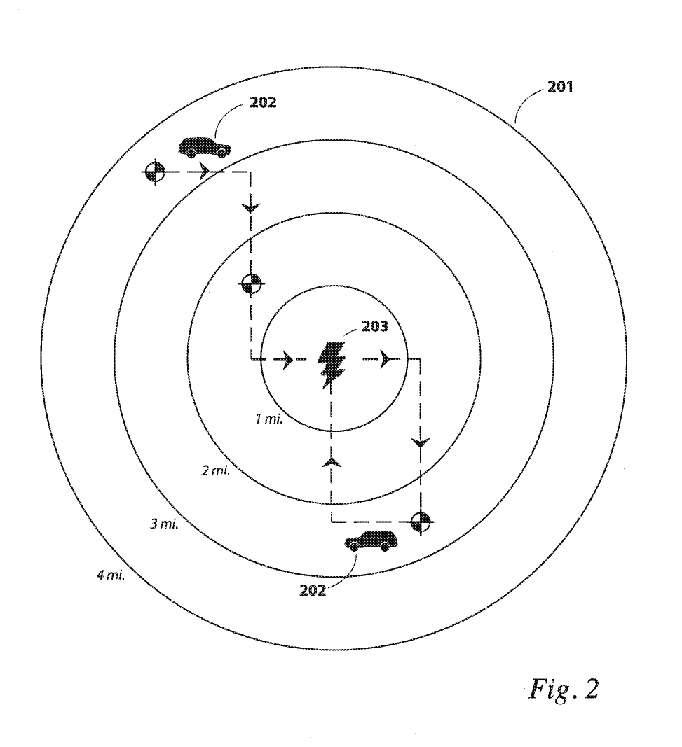

FIG. 2 is a diagram conceptually illustrating a service area 201 covered by an energy distribution source 203 according to an embodiment of the present invention. In several embodiments, the service area 201 may substantially correspond to the service zone 102 of FIG. 1. For example, the service zone 102 and the service area 201 may substantially overlap with each other, and the energy distribution source 203 and the transit node 101 may be located at the same geographic location. However, in several embodiments, the service zone 102 and the service area 201 may not overlap, and the transit node 101 and the energy distribution source 203 may be located at different locations.

Referring to FIG. 2, the service area 201 is serviced by a number of electric vehicles 202 associated with the energy distribution source 203 (e.g., a charging station or battery exchange station). In one embodiment, the service area 201 may correspond substantially to the service zone 102 of FIG. 1, and therefore the transit node 101 in FIG. 1 can also be the energy distribution source 203 where the electric vehicles 202 can be reenergized (e.g., recharged). As such, the zone based organization and distribution of the vehicles 202, aside from improving the accessibility of the mass transit, can provide a favorable model for maintaining and servicing the battery packs of a fleet of electric vehicles.

By restricting the electric vehicles 202 in the service area 201 that may substantially overlap with the service zone 102, the electric vehicles 202 can share a common charging point/system (e.g., 203), In one embodiment, the vehicles 202 may be plug-in electric hybrid vehicles. In another embodiment, the vehicles 202 may be powered by a lithium battery exchange system that can minimize off-service time. In such a battery exchange system, a depleted battery pack of the vehicle 202 is replaced at the energy distribution source 203 with a fully charged battery pack such that the vehicle 202 can remain in service with minimum interruption.

Accordingly, the electric vehicles 202, being restricted to the service area 201, can provide a predetermined and limited range of service around a transit node (e.g., a four mile radius centered upon the transit node), and the vehicles 202 are in constant rotation around the energy distribution source 203 to replenish their batteries. Therefore, this arrangement can yield a constantly running all-electric transportation system that can effectively service a mass transit network. According to the above-described embodiments, the shortcomings such as limited range experienced by current electric car technologies can be overcome. Furthermore, utilizing a battery exchange system (e.g., a lithium battery exchange system) rather than direct, plug-in electric car technologies, allows the transportation system to provide continuous and uninterrupted services to the passengers.

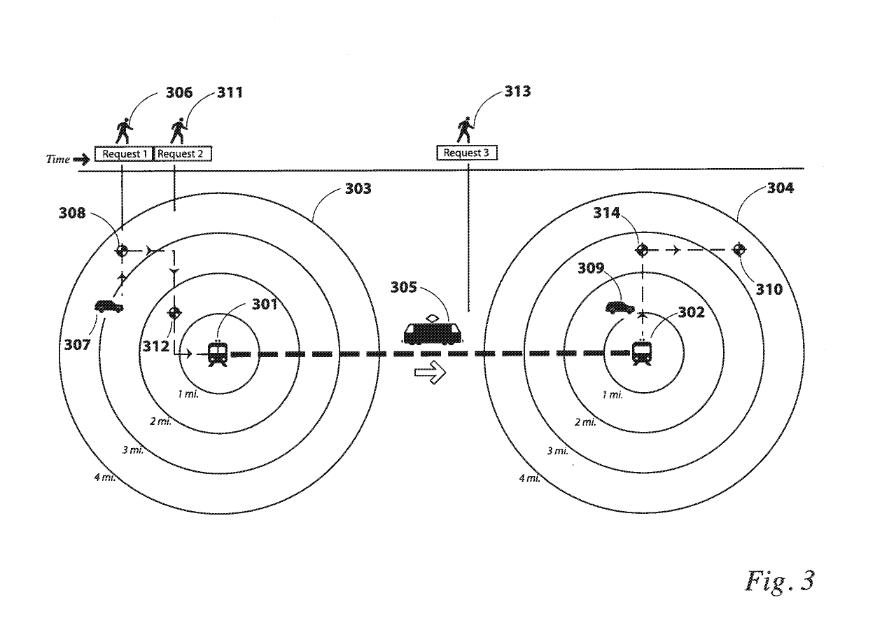

FIG. 3 is a diagram conceptually illustrating the flow of commuters between two transit nodes 301 and 302 that are connected by a transit train 305 according to an embodiment of the present invention. The transit nodes 301 and 302 are respectively associated with two mutually exclusive service zones 303 and 304 in the present embodiment. Referring to FIG. 3, the two transit nodes 301 and 302 are respectively surrounded by two mutually exclusive service zones 303 and 304. In several embodiments, each of the service zones 303 and 304 corresponds to a four mile or fifteen minute service area. The service zones 303 and 304 are connected together by a transit commuter train 305.

Still referring to FIG. 3, individual passenger requests are represented as a time line in this illustration to describe a dynamic, real-time updating scenario of the transportation system of FIG. 3. A request from a first commuter 306 begins a travel itinerary of a first vehicle 307 toward the requested pickup location 308, then toward a drop-off location at a first transit node 301. Concurrently, as an extension of the original travel request, a second vehicle 309 is directed to pick up the commuter 306 arriving at a second transit node 302 associated with the service zone 304. Then, the second vehicle 309 transports the commuter 306 to a final destination 310 that is identified and scheduled as an extension of the original itinerary. Here, the first commuter's entire itinerary includes a first transportation from the point of origin 308 to the first transit node 301, a second transportation by the transit train 305 from the first transit node 301 to the second transit node 302, and a third transportation from the second transit node 302 to the final destination 301. With the known arrival time of the transit train 305 at the second transit node 302, the itinerary of the first commuter 306 is dynamically updated in real time in order to direct the vehicle 309 to meet the commuter 306 at the transit node 302 at the appropriate pickup time. In several embodiments, the commuter 306 may be identified by a vehicle or itinerary number.

Concurrently, at the outset of the vehicle itinerary (e.g., first transportation), a second passenger 311 may initiate a service request that can be handled by the system within the same geographic proximity and time delivery promise of the passenger 306. Therefore, the passenger 311 may be grouped with the passenger 306 in the service zone 303. For example, the itinerary of the passenger 306 can be dynamically updated in real time such that the original route of the vehicle 307 is altered to pickup passenger 311 at a second pickup point 312 to group these passengers together toward the transit node 301. Upon arrival at the transit node 301, the passengers 306 and 311 can continue their journals toward different destinations.

Because the itinerary of the passenger 306 is dynamically updated and scheduled in real time to reflect the eventual arrival time of the passenger 306 at the transit node 302, the itinerary of the passenger 306 can be updated en route to include the delivery of a third passenger 313 to a destination 314. The passenger 306 and the passenger 313 are picked up at the node 302 and delivered to their respective destinations 310 and 314, respectively. The service requests are filtered by the system to identify that the requested destinations 310 and 314 are within favorable time and/or proximity. Accordingly, the utilization of the vehicle 309 can be increased or maximized via the grouping of individual passengers into a single vehicle. In the embodiment of FIG. 3, the first and third passengers 306 and 313 are sorted or grouped into the same vehicle 309 and dropped off at their final destinations as a function of feasible routes and city geography.

The above-described embodiments illustrate a “hot-seating” arrangement that is different from the typical shuttle or taxi service. According the embodiments, independent passengers paying separate fares can be grouped to share the same vehicle to be delivered to their destinations (e.g., a transit station) as effectively and efficiently as possible, as long as the prescribed performance promise to deliver the passengers within a predetermined time limit (e.g., 15 minutes) between the origins/destinations and the respective stations is satisfied.

In some embodiments, grouping of passengers is not compulsory. The system may provide a passenger the option of riding alone in a vehicle. Therefore, if the passenger is in a special hurry or in need of privacy, the passenger may elect to purchase all of the seats within the vehicle by paying the multiple fares.

Referring to FIG. 3, for example, the first passenger 306 can request to have exclusive transit in a non-shared vehicle as a service condition when making the service request. Therefore, the vehicles 307 and 309 will be designated for the sole use of this itinerary. In this case, subsequent requests from passengers 311 and 313 can be re-routed toward other potential groupings with other passenger requests in other vehicles (not shown in FIG. 3).

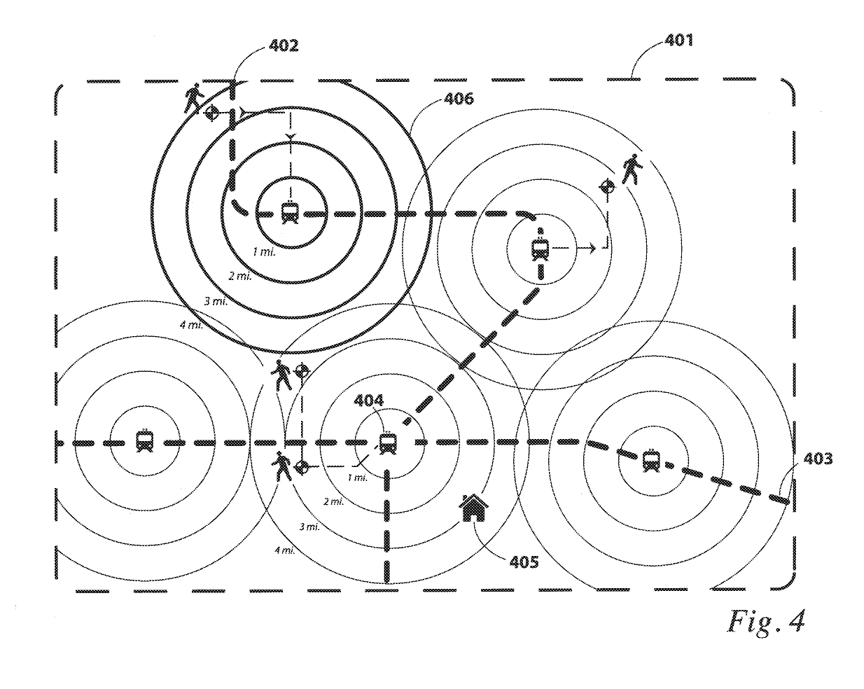

FIG. 4 is a diagram conceptually illustrating an access model of a number of subdivided service zones across a hypothetical transit network covering a city 401 according to an embodiment of the present invention. In FIG. 4, the transit network includes two distinct train lines 402 and 403 sharing a common transit node 404. The embodiment of FIG. 4 combines some features of the embodiments of FIGS. 2 and 3 into a unified transportation system providing universal access to the passengers. This unified transportation system is characterized by an all inclusive, on-demand, door-to-door model of service between regional transit zones in which neighboring zones have partially overlapping service ranges each exclusively serviced by a fleet of passenger vehicles.

In several embodiments of the present invention, a number of drivers (e.g., full-time or part-time drivers) are employed to operate the passenger vehicles within the regional transit zones of FIG. 4. The transportation system is organized according to a model (e.g., a digital model) of service demand in real time. That is, the system can dynamically update the number of drivers in active duty as a function of real time supply and demand for transportation services. Furthermore, in various embodiments, the drivers (e.g., part-time or flexible hour employees) of the vehicles do not need to possess specific knowledge of the service area. Rather, the drivers are directed along the routes that are updated in real time automatically and communicated to the drivers according to the current positions of the vehicles and groupings of passengers.

Referring to FIG. 4, as an example, a part-time or flexible-hour driver resides at his/her residence 405 and requests work within the transportation system. In response, the transportation system (e.g., a computer controlling the transportation system) identifies a zone 406 as an area in demand of extra labor, and the driver is directed to work within the zone 406. Accordingly, the transportation system can provide on-demand employment opportunities that can be extended to the entire city covered by the transportation system. In several embodiments, the transportation system can match the demands for employment and the available employment opportunities via automatic and dynamic updating algorithms. The above-described decision-making functions may be performed by one or more computers or a network of computers that are configured to control the entire transportation system.

In several embodiments, the drivers will direct the individual vehicles according to directions provided by the transportation system and satellite-based techniques such as an onboard satellite-based navigation system or other GPS devices. However, the present invention is not limited thereto. In several embodiments, other suitable automated vehicle guidance technologies can be used to direct the vehicles. One skilled in the art will appreciate that the principles of the present invention as illustrated in the above embodiments can be applied and modified to accommodate future technological advances.

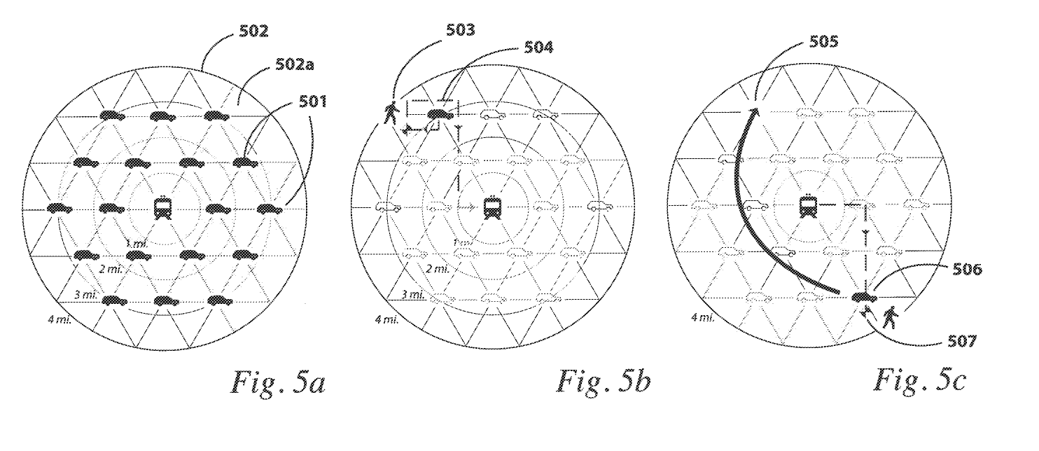

FIGS. 5a through 5c are diagrams conceptually illustrating a strategic distribution of a fleet of vehicles 501 in a service zone 502 according to an embodiment of the present invention. In FIG. 5a, the vehicles 501 are distributed substantially evenly among a number of subareas 502a of the service zone 502 to maximize or increase the effectiveness of the system. The vehicles 501 roam and/or are stationed among the sub-areas 502a awaiting eventual assignment of an individual passenger itinerary. In FIG. 5b, once the transportation system receives a service request from a passenger 503, an itinerary is created to direct a particular vehicle 504 within a close proximity to pickup the passenger 503 and deliver the passenger 503 toward a transit node 505 according to a predetermined delivery schedule and time limit. The vehicle 504 may accept additional passengers en route to the transit node 505 in feasible groupings. In FIG. 5c, an opening 505 created by the vehicle 504, which has left the original location, will be recognized by the transportation system automatically. Then, the transportation system assigns an unoccupied vehicle 506, which may have just dropped off an unrelated passenger at location 507, to fill the vacancy in the sub-area left by the vehicle 504.

This strategic distribution of the vehicles 501 within the service zone 502 approximates a swarm that will assure the speedy or immediate pickup of passengers when service is requested regardless of their initial point of origin within the service area. Inversely, when one of the vehicles 501 leaves a subarea 502a to pick up a passenger, another one of the vehicles 501 currently roaming or stationed in another sub-area 502a will be relocated to fill the position left open by the former vehicle. In this embodiment, the vehicles 501 are dynamically organized and maintained based upon the geography of the service zone 502. Therefore, the entire system (including the vehicles 501 and the existing transit system) can accommodate diverse, individual passenger needs effectively as a function of urban geography and promised delivery time.

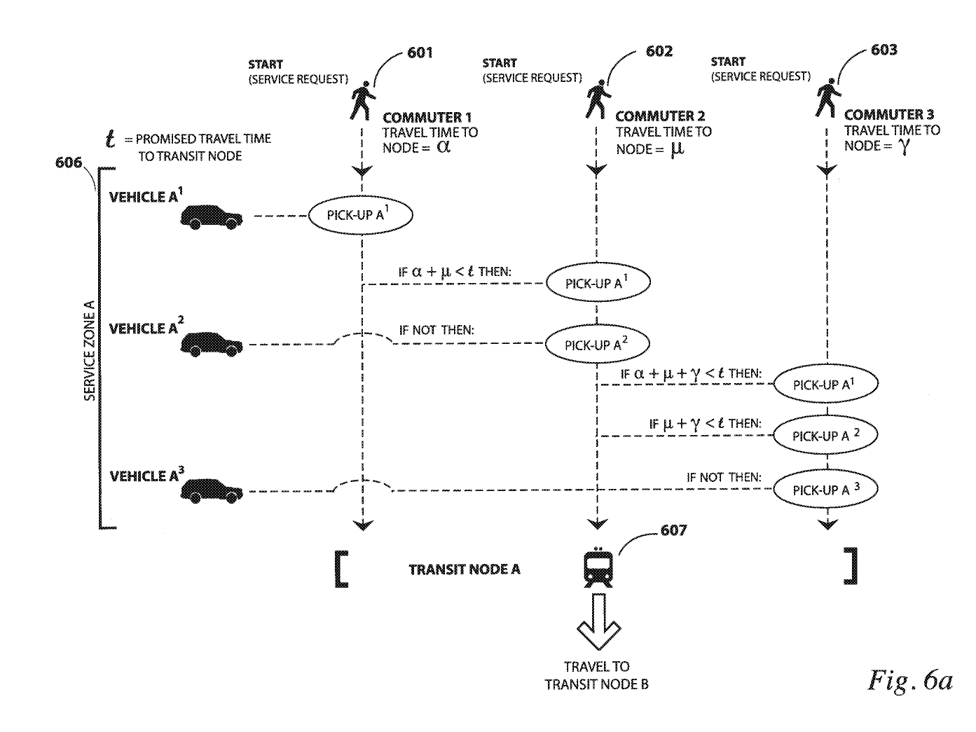

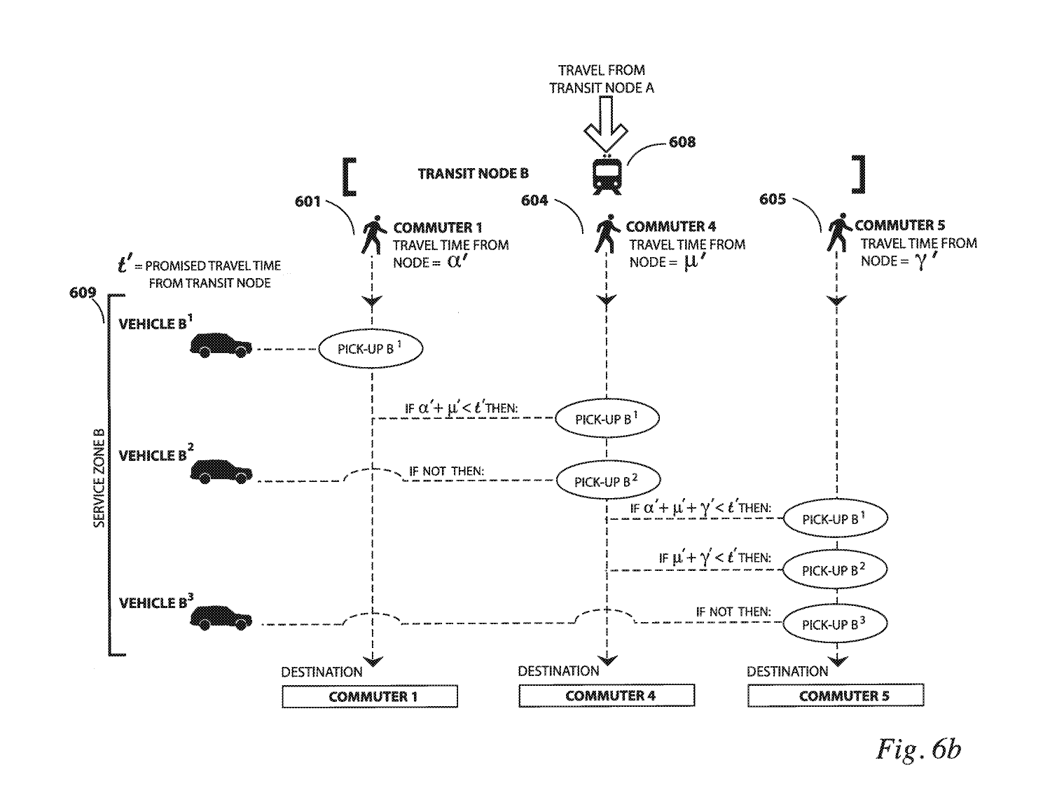

FIGS. 6a and 6b are diagrams illustrating a hypothetical service demand structure exhibited by five distinct commuters (601, 602, 603, 604, and 605) as they enter an on-demand transportation network according to an embodiment of the present invention. Individual passenger requests are sorted as a function of proximity, time of request, and/or potential grouping while maintaining service time promises (t and t′) to and from transit nodes 607 and 608, respectively.

Commuters 601, 602, and 603 originate from different locations within a service zone-A 606. Depending on the time of request relative to the current locations of passenger vehicles A1, A2, and A3, the commuters 601, 602, and 603 are transported either as one or more groups in one or more shared vehicles, or in separate vehicles to a transit node-A 607. Two hypothetical passengers 604 and 605 can join the passenger 601 upon arrival at a transit node-B 608. These passengers can be grouped into one or more groups to share one or more passenger vehicles, or individually transported to their destinations, as a function of their routes toward different destinations within a service zone-B 609. Potential grouping of passengers either in zone-A or zone-B is mathematically and algorithmically decided by the transportation system as a function of transit time between their respective origins and destinations.

The operations of the service demand structure of FIGS. 6a and 6b will now be described in reference to several scenarios as non-limiting examples. Here, t refers to the system promised travel time (e.g., 15 minutes) from pickup to drop-off at the transit node-A, and t′ refers to the system promised travel time (e.g., 15 minutes) from pickup at the transit node-B to drop-off at a destination.

In a first scenario, the vehicle A1 delivers the commuter 601 to the transit node-A if the travel time α for transporting the commuter 601 does not exceed the promised travel time (i.e., α≦t). While the vehicle A1 is en route transporting the commuter 601, the vehicle A1 can pickup the commuter 602 if the sum of the travel time α for transporting the commuter 601 and the travel time μ for transporting the commuter 602 does not exceed the promised travel time (i.e., α+μ≦t). While the vehicle A1 is en route transporting the commuters 601 and 602, the vehicle A1 can pickup the commuter 603 if the sum of the travel time for transporting the commuters 601, 602, and 603 does not exceed the promised travel time (i.e., α+μ+γ≦t).

In a second scenario, the vehicle A1 delivers the commuter 601 to the transit node-A if the travel time α for transporting the commuter 601 does not exceed the promised travel time (i.e., α≦t). However, in this case, the vehicle A1 cannot deliver the commuter 602 because the sum of the travel time for transporting both commuters 601 and 602 will exceed the promised travel time. In this case, a vehicle A2 delivers the commuter 602 to the transit node-A. While the vehicle A2 is en route transporting the commuter 602, the vehicle A2 can pickup the commuter 603 if the sum of the travel time for transporting the commuters 602 and 603 does not exceed the promised travel time (i.e., μ+γ≦t).

In a third scenario, neither of the vehicles A1 nor A2 can deliver the commuter 603. In this case, the vehicle A3 delivers the commuter 603 to the transit node-A.

In a similar fashion, vehicles B1, B2, and B3 deliver the commuters 601, 604, and 605 from the transit zone-B to their respective destinations in various unique groupings in consideration of the travel time. In a fourth scenario, the vehicle B1 can deliver the commuter 601 if the travel time α′ for transporting the commuter 601 does not exceed the promised travel time (i.e., α′≦t′). While the vehicle B1 is en route transporting the commuter 601, the vehicle B1 can pickup the commuter 604 if the sum of the travel time α′ for transporting the commuter 601 and the travel time μ′ for transporting the commuter 604 does not exceed the promised travel time (i.e., α′+μ′≦t′). While the vehicle B1 is en route transporting the commuters 601 and 604, the vehicle B1 can pick up the commuter 605 if the sum of the travel time for transporting the commuters 601, 604, and 605 does not exceed the promised travel time (i.e., α′+μ′+γ′≦t′).

In a fifth scenario, the vehicle B1 picks up the commuter 601 at the transit node-B if the travel time α′ for transporting the commuter 601 to the destination is less than or equal to the promised travel time (i.e., α′≦t′). However, the vehicle B1 cannot deliver the commuter 604 because the sum of the travel time for transporting both commuters 601 and 604 will exceed the promised travel time t′. In this case, the vehicle B2 picks up the commuter 604 at the transit node-B. While the vehicle B2 is en route transporting the commuter 604 to the destination, the vehicle B2 can pickup the commuter 605 if the sum of the travel time for transporting the commuters 604 and 605 does not exceed the promised travel time t′ (i.e., μ′+γ′≦t′).

In a sixth scenario, neither of the vehicles B1 nor B2 can pick up the commuter 605. In this case, the vehicle B3 picks up the commuter 605 at the transit node-B.

In the above scenarios, unique and varied travel times (α, μ, γ) of the commuters (601, 602, 603) to the transit node-A and respective travel times (α′, μ′, γ′) from their (601, 604, 605) arrival at transit node-B are calculated additively in relation to the promised system travel times t and t′. If groupings are favorable or feasible, individual passengers are transported together to maximize efficiency and cost effectiveness of the whole system.

### Computerized Implementation

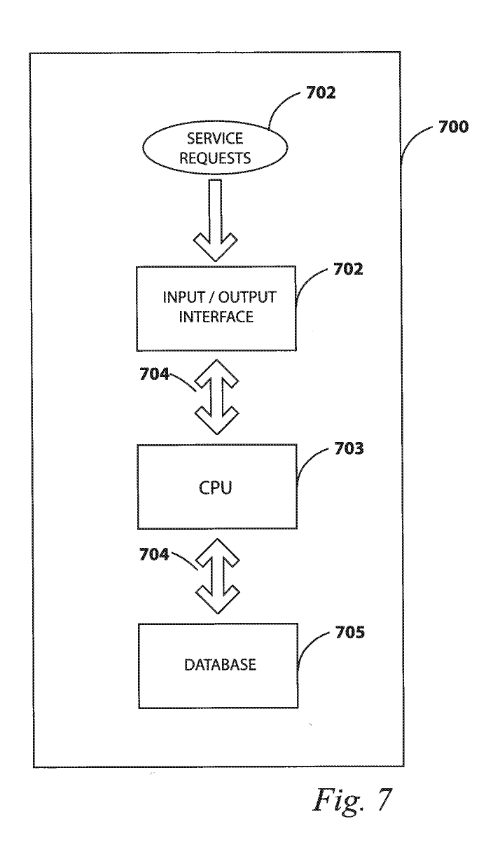

FIG. 7 is a block diagram illustrating a computer system 700 for handling the above described functions of a door-to-door and on-demand transportation system such as scheduling and updating of routes, grouping of passengers, labor utilization, billing, etc., according to an embodiment. Referring to FIG. 7, the computer system 700 has an input/output interface 702 for receiving commuter service requests 712 and/or sending directions and itineraries to the passenger vehicles. The commuter service requests may be directed to a central processing unit (CPU) 703 via a data network 704. The CPU 703 may be a single computer or multiple computers operating cooperatively, and the computers may be located at the same location or different locations. In addition, the computer system 700 has a database 705 for storing the requests and other system data in order to handle the above-described functions of the transportation system. However, the present invention is not limited to the embodiment of FIG. 7. In several embodiments, the computer system 700 may have other configurations including additional elements that are commonly known to one skilled in the art.

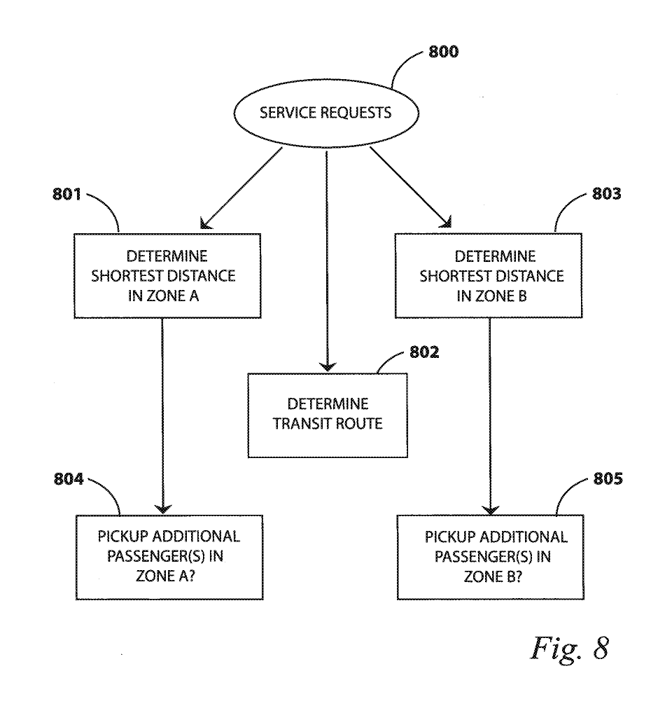

FIG. 8 is a flowchart illustrating the processes performed by the computer system 700 to determine an itinerary for a passenger according to an embodiment of the present invention. Referring to FIG. 8, the transportation system receives a request 800 from a passenger A1 who wants to travel from zone-A to zone-B. Here, zone-A and zone-B are connected by a transit train. In response to the request 800, the computer system 700 performs three different processes 801, 802, and 803 in order to determine the feasible route. In the process 801, the computer system 700 locates a passenger vehicle in zone-A that is within the shortest distance from the origin of the passenger A1 based on a shortest travel time algorithm, and directs this vehicle to transport the passenger A1 to a transit node in zone-A. In the process 802, the computer system 700 determines a suitable train schedule to transport the passenger A1 from zone-A to zone-B. In one embodiment, the computer system 700 chooses a train schedule that will minimize the waiting time of the passenger at the transit node in zone-A. In the process 803, the computer system 700 locates a passenger vehicle in zone-B that is within the shortest distance from the passenger A1 arriving at the transit node in zone-B based on a shortest travel time algorithm, and directs this vehicle to transport the passenger A1 to the destination. In this embodiment, the processes 801, 802, and 803 can be processed concurrently or in other feasible orders.

In process 804, while a vehicle is en route transporting the passenger A1 in zone-A, the computer system 700 may determine whether or not additional passenger(s) may be picked up and transported together in group with the passenger A1 according to the constraints illustrated in FIGS. 6a and 6b. Similarly, in process 805, while a vehicle is en route transporting the passenger A1 in zone-B, the computer system 700 may determine whether or not additional passenger(s) may be picked up and transported together in group with the passenger A1 according to the constraints illustrated in FIGS. 6a and 6b.

According to the above-described embodiments, an individual passenger may make a request to the transportation system via the telephone, the internet, a mobile device, or any suitable device that is in communication with the system. In response, the transportation system generates an itinerary in which a pickup location, a drop-off location, and promised delivery time are defined. In addition, the itinerary may include transit train schedule if a train ride is a part of the itinerary. The computer system (e.g., 700) continuously updates this itinerary to search for suitable grouping with complementary itineraries of other passengers in both a departure zone (e.g., transit node-A of FIG. 6a) and an arrival zone (e.g., transit node-B of FIG. 6b). If complementary itineraries are identified for grouping, a passenger's route can be modified to accommodate an additional passenger at no cost difference to either passengers on the condition that the promised service time can be maintained. While the passengers are waiting to be picked up, real-time updates may be sent to the passengers showing the movement of the assigned vehicles. The drivers of the vehicles are automatically routed and directed by the system and an on-board guidance system (e.g., GPS navigation) that monitors the whereabouts of the vehicles and their respective routes. The routes of the vehicles are dynamically updated to meet the transportation needs of other passengers.

In the above-described embodiments, the travel itineraries are defined and implemented in a digital or computerized network that may provide increased security within the whole system. For example, the system can identify and track the progress of each passenger throughout the system. Further, the digital or computerized network can facilitate an organized and convenient system of billing and payment. In several embodiments, mobile applications (e.g., smartphone applications) can monitor each individual's usage of the system to dynamically update billing in the form of tickets or tolls.

According to the described embodiments, a self-organizing computerized transportation system can continuously refine and update data collection toward maximizing the overall efficiency, profitability, and user friendliness of the transit system. For example, scheduling, number of vehicles, number and frequency and length of individual trains, and employment labor opportunities can by dynamically analyzed and updated with changing usage patterns as a function of time, commuter behavior, or seasonal variances. According to the embodiments, a transportation system is “self-organized” according the data input. That is, based on the service requests entered by, for example, an internet connected device, a route map is automatically generated including a pickup vehicle in an origin zone, an appropriately scheduled train or transit to deliver the passenger to the drop-off zone, and/or a vehicle which will deliver the individual commuter to the destination. In several embodiments, third-party providers, e.g., cell phone network providers, internet service providers, etc. can act as an agent for collecting transit tolls and fares using the digital or computerized network.

While the present invention has been particularly shown and described with reference to exemplary embodiments thereof, it will be understood by those of ordinary skill in the art that various changes in form and details may be made therein without departing from the spirit and scope of the present invention as defined by the following claims, and their equivalents.

What is claimed is:

1. A transportation system comprising:
a first fleet configured to operate in a first service zone having a first node to transport passengers exclusively in the first service zone according to instructions dynamically determined in real time;
a second fleet configured to operate in a second service zone having a second node, excluding the first node, to transport passengers exclusively in the second service zone according to instructions dynamically determined in real time; and
a control center in data communication with the first fleet and the second fleet for providing the instructions to the first fleet and the second fleet,
wherein the control center is configured to direct a first vehicle from the first fleet to transport a first passenger between a first location and the first node in response to a service request initiated by the first passenger according to the instructions that are dynamically determined in real time in consideration of the first location, a current location of the first vehicle, and a first predetermined travel time between the first location and the first node.

2. The transportation system of claim 1, wherein the control center is further configured to:
direct the first vehicle to pickup a second passenger from a second location in response to a service request initiated by the second passenger while transporting the first passenger; and
modify the instructions in real time in consideration of the second location such that the first passenger is transported to the first node or the first location within the first predetermined travel time.

3. The transportation system of claim 1, wherein the control center is configured to:
direct the first vehicle to transport the first passenger from the first node to the first location within the first predetermined travel time and
modify the instructions in real time to direct the first vehicle to transport a second passenger,
wherein the first vehicle transports both the first passenger and the second passenger during at least a portion of the first predetermined travel time.

4. The transportation system of claim 1, wherein the control center is further configured to:
direct a second vehicle from the second fleet to transport the first passenger between the second node and a second location in response to the service request initiated by the first passenger according to instructions that are dynamically determined in real time in consideration of an arrival time of the first passenger at the second node, the second location, the current location of the second vehicle, and a second predetermined travel time between the second location and the second node.

5. The transportation system of claim 4,
further comprising a third fleet configured to operate in a third service zone to transport passengers of a third node exclusively in the third service zone according to instructions dynamically determined in real time, and
the control center is further configured to:
direct a third vehicle from the third fleet to transport a second passenger between a third location and the third node in response to a service request initiated by the second passenger according to the instructions that are dynamically determined in real time in consideration of the third location, the current location of the third vehicle, and a third predetermined travel time between the third location and the third node; and
modify the instructions in real time in consideration of the arrival time of the second passenger at the second node to direct the second vehicle to transport the second passenger in addition to the first passenger, wherein the second vehicle transports both the first passenger and the second passenger during at least a portion of the second predetermined travel time.

6. The transportation system of claim 4, wherein the control center is further configured to:
direct the second vehicle to transport the first passenger from the second node to the second location within the second predetermined travel time; and
modify the instructions in real time to direct the second vehicle to transport a second passenger,
wherein the second vehicle transports both the first passenger and the second passenger during at least a portion of the second predetermined travel time.

7. The transportation system of claim 1,
wherein the first fleet and second fleet comprise electric vehicles, and
wherein the control center is further configured to periodically direct the electric vehicles to corresponding energy distribution sources respectively located in the first service zone and the second service zone.

8. The transportation system of claim 1, wherein the first location of the first passenger is determined by a satellite-based technique.

9. The transportation system of claim 1, wherein the current location of the first vehicle is determined by a satellite-based technique.

10. The transportation system of claim 1, wherein the first vehicle is directed according to satellite-based guidance.

11. The transportation system of claim 1, wherein the control center is further configured to provide the current location of the first vehicle to the first passenger in real time while directing the first vehicle toward the first passenger.

12. The transportation system of claim 1, wherein the service request initiated by the first passenger comprises a service condition directing the first vehicle to transport the first passenger exclusively between the first location and the first node.

13. The transportation system of claim 1, wherein the instructions are determined by a shortest distance algorithm or a shortest travel time algorithm.

14. The transportation system of claim 1,
wherein the first service zone is divided into a plurality of sub-areas, and
wherein the control center is configured to dynamically distribute vehicles of the first fleet substantially evenly among the sub-areas.

15. The transportation system of claim 14,
wherein the sub-areas comprise a first sub-area and a second sub-area, and
wherein the control center is further configured to reassign one or more of the vehicles from the first sub-area to the second sub-area that has fewer number of the vehicles available for transporting passengers than that of the first sub-area.

16. The transportation system of claim 1, wherein the control center is further configured to debit an account of the first passenger a fare determined based on the number of passengers in the first vehicle.

17. A method for operating a transportation service, comprising:
operating a first fleet in a first service zone having a first node to transport passengers exclusively in the first service zone according to instructions dynamically determined in real time;
operating a second fleet in a second service zone having a second node, excluding the first node, to transport passengers exclusively in the second service zone according to instructions dynamically determined in real time; and
directing a first vehicle from the first fleet to transport a first passenger between a first location and the first node in response to a service request initiated by the first passenger according to the instructions that are dynamically determined in real time in consideration of the first location, a current location of the first vehicle, and a first predetermined travel time between the first location and the first node.

18. The method of claim 17, further comprising:
directing the first vehicle to pickup a second passenger from a second location in response to a service request initiated by the second passenger while transporting the first passenger; and
modifying the instructions in real time in consideration of the second location such that the first passenger is transported to the first node or the first location within the first predetermined travel time.

19. The method of claim 17, wherein directing the first vehicle comprises:
directing the first vehicle to transport the first passenger from the first node to the first location within the first predetermined travel time; and
modifying the instructions in real time to direct the first vehicle to transport a second passenger,
wherein the first vehicle transports both the first passenger and the second passenger during at least a portion of the first predetermined travel time.

20. The method of claim 17, further comprising directing a second vehicle from the second fleet to transport the first passenger between the second node and a second location in response to the service request initiated by the first passenger according to instructions that are dynamically determined in real time in consideration of an arrival time of the first passenger at the second node, the second location, the current location of the second vehicle, and a second predetermined travel time between the second location and the second node.

21. The method of claim 20, further comprising:
operating a third fleet in a third service zone to transport passengers of a third node exclusively in the third service zone according to instructions dynamically determined in real time;
directing a third vehicle from the third fleet to transport a second passenger between a third location and the third node in response to a service request initiated by the second passenger along instructions that are dynamically determined in real time in consideration of the third location, the current location of the third vehicle, and a third predetermined travel time between the third location and the third node; and
modifying the instructions in real time in consideration of the arrival time of the second passenger at the second node to direct the second vehicle to transport the second passenger in addition to the first passenger, wherein the second vehicle transports both the first passenger and the second passenger during at least a portion of the second predetermined travel time.

22. The method of claim 20, wherein directing the second vehicle comprises:
directing the second vehicle to transport the first passenger from the second node to the second location within the second predetermined travel time; and
modifying the instructions in real time to direct the second vehicle to transport a second passenger,
wherein the second vehicle transports both the first passenger and the second passenger during at least a portion of the second predetermined travel time.

23. The method of claim 17,
wherein the first fleet and the second fleet comprise electric vehicles,
further comprising periodically directing the electric vehicles to corresponding energy distribution sources located in the first service zone and the second service zone.

24. The method of claim 17, wherein the service request initiated by the first passenger originates from a mobile device, a landline telephone, or a networked computing device.

25. The method of claim 17, wherein the first location of the first passenger is determined by a satellite-based technique.

26. The method of claim 17, wherein the current location of the first vehicle is determined by a satellite-based technique.

27. The method of claim 17, wherein the first vehicle is directed according to satellite-based guidance.

28. The method of claim 17, further comprising providing the current location of the first vehicle to the first passenger in real time while directing the first vehicle toward the first passenger.

29. The method of claim 17, wherein the service request initiated by the first passenger comprises a service condition directing the first vehicle to transport the first passenger exclusively between the first location and the first node.

30. The method of claim 17, wherein the instructions are determined by a shortest distance algorithm or a shortest travel time algorithm.

31. The method of claim 17, further comprising:
dividing the first service zone into a plurality of sub-areas; and
distributing vehicles of the first fleet substantially evenly among the sub-areas.

32. The method of claim 31,
wherein the sub-areas comprise a first sub-area and a second sub-area,
further comprising reassigning one or more of the vehicles in the first sub-area to the second sub-area that has fewer number of the vehicles available for transporting passengers than that of the first sub-area.

33. The method of claim 17, further comprising debiting an account of the first passenger a fare determined based on the number of passengers in the first vehicle.
